(19) United States
(12) Patent Application Publication
(10) Pub. No.: US 2013/0232829 A1
(43) Pub. Date: Sep. 12, 2013

(54) CRYPT PLAQUES AND METHOD OF DISPLAYING SAME

(71) Applicant: M. Curtis Voiles, Whiteland, IN (US)

(72) Inventor: M. Curtis Voiles, Whiteland, IN (US)

(21) Appl. No.: 13/413,296

(22) Filed: Mar. 6, 2012

(51) Int. Cl. G09F 19/00; B23P 11/00

(52) U.S. Cl. 40/124.5; 29/428; 29/525.11

(57) ABSTRACT

Crypt plaques and a method for displaying same including the steps of providing a grid or matrix of abutting crypts, with the front of each crypt able to receive a customized plaque as well as a nameplate of dimensions identical to those used on the other crypts, and providing metallic plaques each bearing a customized, etched collage of imagery and/or wording relating to the deceased interred in a given crypt. The plaques share a common size and are affixed to the various crypt fronts behind their respective standardized nameplate. The plaques thus provide an aesthetically pleasing appearance when the crypts are viewed collectively along a mausoleum wall while allowing loved ones to customize each crypt to uniquely honor the deceased via a memorial that is not easily removed from the crypt. The plaques may be cast bronze, with the relief imagery and any text generated by hand and/or computer-implemented means.

### FIELD OF THE INVENTION

The present disclosure relates to markers at entombment locations and other points of interest, and, more particularly, to a method of displaying memorial plaques on crypt fronts.

### BACKGROUND

Individuals' desire to remember and honor their loved ones who are deceased is considerable and needs no elaboration. To assist in this regard, crypts, sometimes referred to as burial vaults, are frequently found in cemeteries' mausolea and underneath public religious buildings, such as churches. Crypts are also occasionally built on personal estates, providing families with a place where all members of a given family may be interred.

More specifically, mausoleums efficiently provide above-ground interment spaces in a plurality of individual abutting crypts which are arranged, in a grid or matrix style, along a wall in horizontal tiers and vertical rows. Each crypt typically has a drawer front which is formed of marble or another natural or artificial stone. The crypt front is usually inscribed with information identifying the person interred or, via screws or bolts, has affixed to it a nameplate. The format of the nameplates, including their sizes and shapes, commonly vary within a mausoleum.

Crypt fronts are often decorated, physically apart from the nameplates, as a tribute and form of remembrance. Such scattered ornamentation can be in the form of a floral arrangement, with or without a supporting element such as a vase, emblems or other embellishments, or plaques of varying sizes and styles. This non-uniform ornamentation, while serving a noble purpose, can significantly detract from the overall appearance of the crypts when they are viewed collectively. In addition to not being aesthetically pleasing, existing crypt ornamentation attempts often involve gluing or otherwise adhering the flowers, images, or other embellishments to the crypt fronts, but problems arise in that such adornments may be removed relatively easily.

### SUMMARY OF THE INVENTION

The present invention may comprise one or more of the following features and combinations thereof.

In one illustrative embodiment of the present method, a grid or matrix of abutting crypts is provided as a first step, with the front of each crypt able to receive a customized plaque as well as a name plate of dimensions identical to those used on the other crypts. The plaques may be metallic plaques, each bearing a customized, etched collage of imagery and/or wording relating to the deceased. Sized to match the dimensions of the crypt front or sharing another common size, as further steps, these plaques are then situated behind their corresponding nameplates and affixed to the crypt fronts by means such as screws or bolts of a length sufficient to pass through a nameplate and plaque and retain them. Additional holes may be required in the crypt fronts in order to affix the plaques to the crypt fronts. The metallic plaques may be cast bronze. It is also possible that the relief imagery and any text on the plaques is generated by hand and/or computer-implemented means known in the art.

As noted, the plaques are utilized in connection with standardized nameplates, which provides an aesthetically pleasing appearance for the entire collection of crypts while retaining the ability to customize each crypt to uniquely honor and remember those who have passed. In addition to an overall consistent appearance in a crypt, the method provides the benefit of memorial permanence. It should be noted that the application of the plaques and nameplates to the crypts in a given collection need not occur at one time, but may occur over the course of time as

Additional features of the disclosure will become apparent to individuals skilled in the art upon consideration of the following detailed description of the illustrative embodiments.

### BRIEF DESCRIPTION OF THE DRAWINGS

The detailed description particularly refers to the accompanying figures in which:

FIG. 1 is a front-perspective view of an illustrative crypt front produced when practicing the method disclosed herein; and

FIG. 2 is a perspective, partial view of a plurality of crypts with an exploded view of a plaque and nameplate, with crypt each having the type of front illustrated in FIG. 1.

### DETAILED DESCRIPTION OF THE ILLUSTRATIVE EMBODIMENTS

For the purposes of promoting and understanding the principles of the invention, reference will now be made to one or more embodiments illustrated in the drawings and specific language will be used to describe the same.

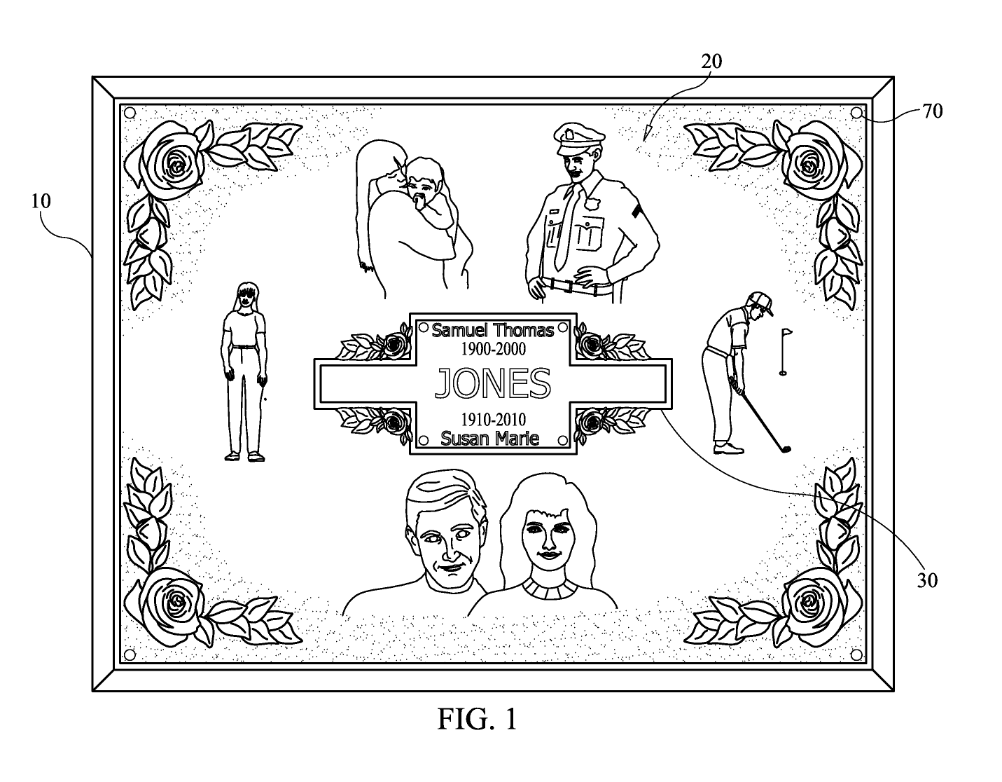

Referring to FIG. 1, an illustrative embodiment of the present method involves the use of a plaque 10, bearing a customized collage 20 of imagery and/or text, to be placed in a mausoleum or other location of significance. The collage 20 will thus relate to an individual in a crypt or otherwise in some way to the particular location. The plaque 10 may be a metallic, cast bronze panel in one embodiment, and have a raised or sunken collage 20 that is manufactured via a mechanical process, including a computer-assisted or controlled one, or the required relief created by hand, as is known in the metallurgical and sculpting arts. The plaque 10 is utilized in connection with a nameplate 30.

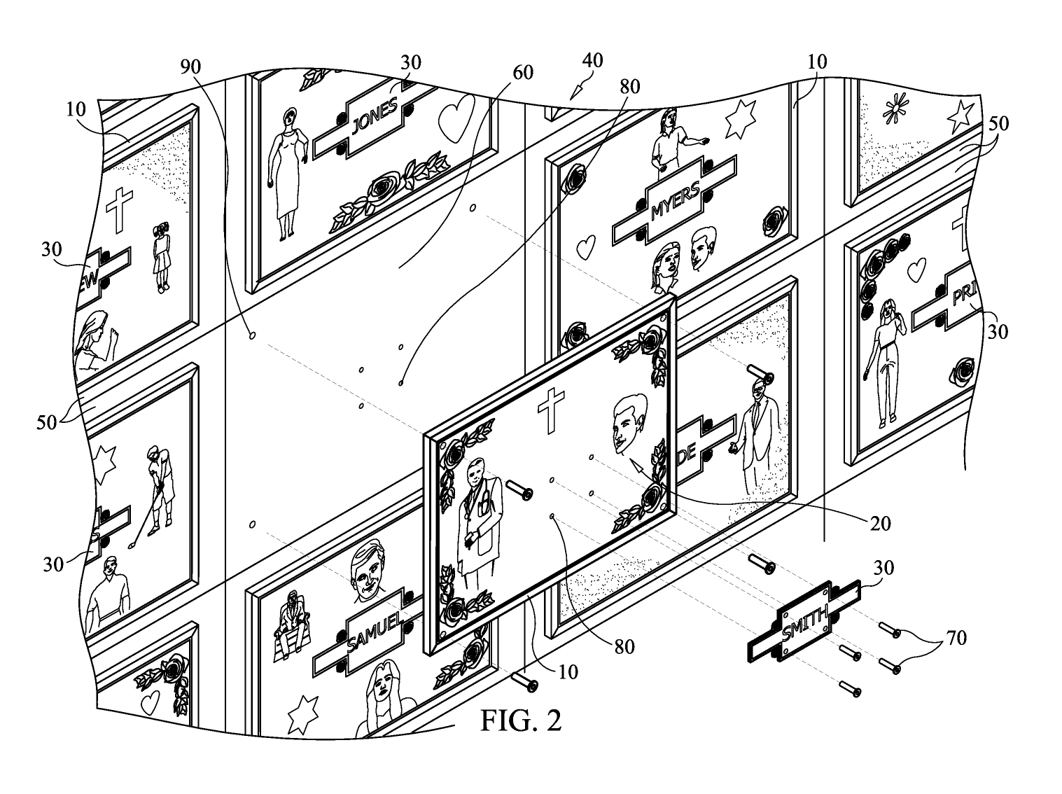

The method commences with the step of providing a grid or matrix 40 of abutting crypts 50, an example of which is depicted in FIG. 2, with the front 60 of each crypt 50 able to receive a customized plaque 10 as well as a nameplate 30. The method continues with the step of providing a plurality of customized plaques 10 and nameplates 30. Each nameplate 30 may be of a type or style already employed by a given cemetery and is standardized in that it has a shape and dimensions identical to those of the nameplates 30 used on the other crypts 50.

Sized to match, or at least fit within, the dimensions of the crypt front 60 or sharing another common size, the plaques 10 are positioned behind their corresponding nameplates 30 and then affixed to the crypt fronts 60. The affixing means include, but are not limited to, screws 70 or bolts of a length and rigidity sufficient to pass through a nameplate 30 and plaque 10 and retain them to the front 60. Inner holes 80 drilled or otherwise cut into the crypt fronts 60 should spatially correspond to the positions of the holes 80 cut in the plaques 10 and nameplates 30. It should be noted that additional, outer holes 90 may be required in the crypt fronts 60 in order to affix the plaques 10 to the fronts 60.

When viewed collectively after installation, the plaques 10 on the crypt 50 provide an aesthetically-pleasing array of imagery 20 in a context that is standardized by the grid-like arrangement of the crypts 50 and the use of the identically-styled nameplates 30.

As noted, the plaques 10 are metallic in one embodiment and may be cast bronze. The shape of the plaques 10 is not restricted, but it can mirror the common, generally rectangular crypt front 60 shape. The nameplates 30 may be composed of similar material. The materials for the plaques 10 and nameplates 30 are not limited, however, and may be other metals such as aluminum, brass, copper, or other alloys. The layout options for each plaque 10 are virtually unlimited and graphic design considerations may come into play. It is envisioned that photographs may be scanned or otherwise input into a computer-controlled or aided manufacturing system in order to generate highly-detailed, relief-style imagery on the plaques 10. As is known in the manufacturing software art and disclosed in U.S. Pat. No. 7,814,959 to Karenbauer, the scanned photographs will be converted to a digital representation, and software may be used to determine the appropriate tool path for routing a polyurethane or other pattern of the imagery 20. Molten metal such as bronze may then be introduced into the pattern to make the detailed plaque 10. In light of the identifying information on the nameplates 30, the plaques 10 need not bear any wording, but the type of textual information on each plaque 10 may include a name and important dates. The nameplates 30, though, need not bear names or merely information to identify a person.

It should be understood, however, that the context for practicing the present method is by no means limited to mausolea and crypts. Virtually any setting where there is a grid or matrix-type of arrangement of abutting, generally flat surfaces capable of receiving the plaques 10 and a standardized marker similar to the nameplates 30 will suffice. Moreover, it should be understood that all of the illustrated steps are merely exemplary. Other steps may be added, some may be omitted, and variations in the step sequence are envisioned, and the order of the steps may certainly be changed for differing settings for the plaques 10.

While the invention has been illustrated and described in detail in the foregoing drawings and description, the same is to be considered as illustrative and not restrictive in character, it being understood that only illustrative embodiments thereof have been shown and described and that all changes and modifications which are within the scope of the claimed subject matter are desired to be protected.

1. A method of displaying crypt plaques comprising the steps of:
Providing a grid or matrix comprising a plurality of enclosed crypts having crypt fronts which are each capable of receiving a customized metallic plaque and a nameplate thereon;
Providing a plurality of metallic plaques sharing a common size and shape and customized with imagery and/or text;
Providing a plurality of nameplates sharing a common size and shape; and
Affixing the plaques and the nameplates to the crypt fronts such that, for each crypt front, a single plaque is positioned between the crypt front and a corresponding nameplate.

2. The method of claim I wherein the plaques are composed of bronze.

3. The method of claim I wherein the plaques and nameplates are affixed to the crypt fronts by screws or bolts.

4. The method of claim 2 wherein the plaques are each configured to have a shape matching that of the crypt fronts.

5. The method of claim 1 wherein the plaques bear imagery generated by a computer-controlled manufacturing system.

6. A collection of crypt plaques comprising:
A grid or matrix comprising a plurality of enclosed crypts having crypt fronts which are each capable of receiving a customized metallic plaque and a nameplate thereon;
A plurality of metallic plaques sharing a common size and shape and customized with imagery and/or text; and
A plurality of nameplates sharing, a common size and shape,
Wherein the plaques and the nameplates are affixed to the crypt fronts such that, for each crypt front, a single plaque is positioned between the crypt front and a corresponding nameplate.

7. The collection of crypt plaques of claim 6 wherein the plaques are composed of bronze.

8. The collection of crypt plaques of claim 6 wherein the plaques and nameplates are affixed to the crypt fronts by screws or bolts.

9. The collection of crypt plaques of claim 6 wherein the plaques are each configured to have a shape matching that of the crypt fronts.

10. The collection of crypt plaques of claim 6 wherein the plaques bear imagery generated by a computer-controlled manufacturing system.

11. The collection of crypt plaques of claim 10 wherein the crypt fronts comprise generally rectangular pieces of natural or artificial stone that conllectively form a planar mounting surface for the plurality of metallic plaques.

12. The method of claim 5 wherein the crypt fronts comprise generally rectangular pieces of natural or artificial stone that collectively form a planar mounting surface for the plurality of metallic plaques.
